(19) United States
(12) Patent Application Publication
(10) Pub. No.: US 2019/0086019 A1
(43) Pub. Date: Mar. 21, 2019

(54) Joint that Prevents a Water Pipe from Twisting

(71) Applicants: Water Boger Hardware (Shenzhen) Co., Ltd., Shenzhen City (CN); Water Boger Biochemical Technology Co., Ltd., Yuanlin Township (TW)

(72) Inventor: Po An Teng, Shenzhen City (CN)

(73) Assignees: Water Boger Hardware (Shenzhen) Co., Ltd.; Water Boger Biochemical Technology Co., Ltd.

(21) Appl. No.: 15/832,269

(22) Filed: Dec. 5, 2017

(30) Foreign Application Priority Data
Sep. 20, 2017 (CN) 201721215003.2

(51) Int. Cl. F16L 55/178; F16L 15/04; F16L 21/08

(52) U.S. Cl. CPC F16L 55/178; F16L 3/1211; F16L 21/08; F16L 15/04

(57) ABSTRACT

A joint for preventing a water pipe from twisting comprises a hanger screw sleeve, a disk-shaped oil seal, a gasket and a connecting pipe. The disk-shaped oil seal is sleeved on one end of the connecting pipe, and the water pipe is sleeved on the other end thereof. The gasket is disposed between the disk-shaped oil seal and the connecting pipe. The disk-shaped oil seal, the gasket and the connecting pipe are all arranged in the hanger screw sleeve. As the hanger screw sleeve screws into a water pipe base and presses onto the disk-shaped oil seal, the disk-shaped oil seal and the gasket also rotate together with the hanger screw sleeve. This prevents the water pipe connecting to the joint from twisting.

### FIELD OF THE INVENTION

The invention relates to a joint and, in particular, to a joint that prevents a water pipe from twisting.

### BACKGROUND OF THE INVENTION

All existing water pipes are generally composed of a core and a hanger screw sleeve. During the installation of the water pipe, the head of the core is generally sleeved onto a water hose. The hanger screw sleeve is then screwed onto the base of the water hose, thereby fixing the core and preventing water leakage. However, when the core is connected with the hose and the hanger screw sleeve is rotated to compress against the core, the core rotates with the hanger screw sleeve. The hose is then driven to rotate and twist. Such twists not only shorten the lifetime of the water pipe, they also affect normal flow of the fluid therein and do not look good.

### SUMMARY OF THE INVENTION

In order to solve the above-mentioned problems, the invention provides a joint for preventing the water pipe from twisting. As the hanger screw sleeve screws into a water pipe base and presses onto the disk-shaped oil seal, the disk-shaped oil seal and the gasket also rotate together with the hanger screw sleeve. As there is no twist, the invention greatly improves the lifetime of water pipes.

The disclosed joint for preventing a water pipe from twisting includes: a hanger screw sleeve, a disk-shaped oil seal, a gasket, and a connecting pipe. The disk-shaped oil seal is sleeved on one end of the connecting pipe, and the water pipe is sleeved on the other end thereof. The gasket is disposed between the disk-shaped oil seal and the connecting pipe. The disk-shaped oil seal, the gasket and the connecting pipe are all arranged in the hanger screw sleeve. As the hanger screw sleeve screws into a water pipe base and presses onto the disk-shaped oil seal, the disk-shaped oil seal and the gasket also rotate together with the hanger screw sleeve.

Furthermore, the disk-shaped oil seal includes: a seal ring, a convex ring, a filter and a plurality of bosses disposed around the seal ring. The convex ring is disposed on one side of the seal ring. The filter is disposed inside the convex ring.

Moreover, the filter is a 50-mesh stainless steel filter.

Except for the filter, the disk-shaped oil seal is made of a nitrile rubber material.

Furthermore, a steel sleeve is arranged on the end of the connecting pipe that is connected with the water pipe. The steel sleeve is used to fasten the water pipe onto the connecting pipe of the joint.

Different from the integrated design of the water pipe joint and the core in the prior art, the invention provides a joint for preventing the water pipe from twisting. Its advantage is that: the hanger screw sleeve screws into a water pipe base and presses onto the disk-shaped oil seal, the disk-shaped oil seal and the gasket also rotate together with the hanger screw sleeve. The connected water does not rotate and therefore does not twist. The disk-shaped oil seal also has a better sealing effect.

### BRIEF DESCRIPTION OF THE DRAWINGS

FIG. 1 is a front cross-sectional view of the disclosed joint for preventing a water pipe from twist;

FIG. 2 is a three-dimensional view of the disk-shaped oil seal of the disclosed joint for preventing a water pipe from twist;

FIG. 3 is a front view of the gasket of the disclosed joint for preventing a water pipe from twist; and

FIG. 4 is a front cross-sectional view of the connecting pipe of the disclosed joint for preventing a water pipe from twist.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

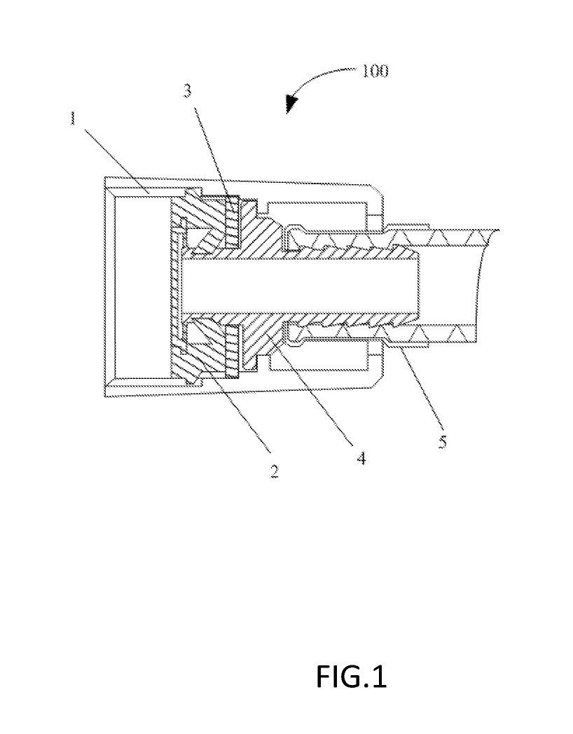

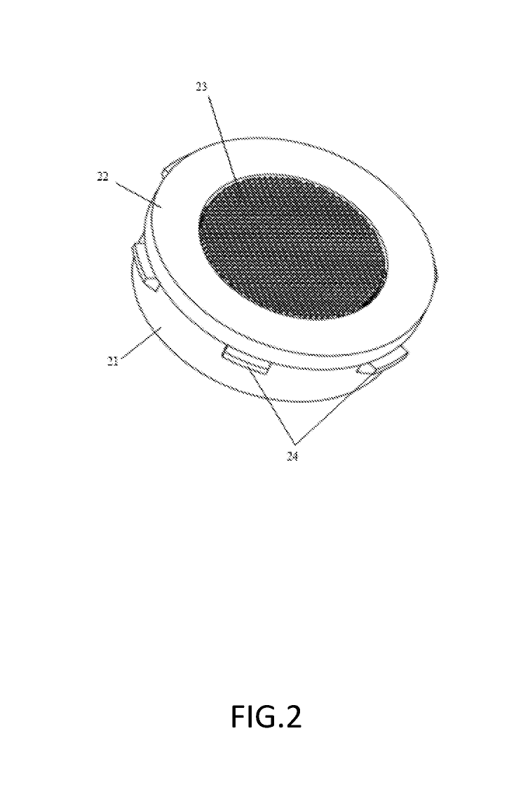

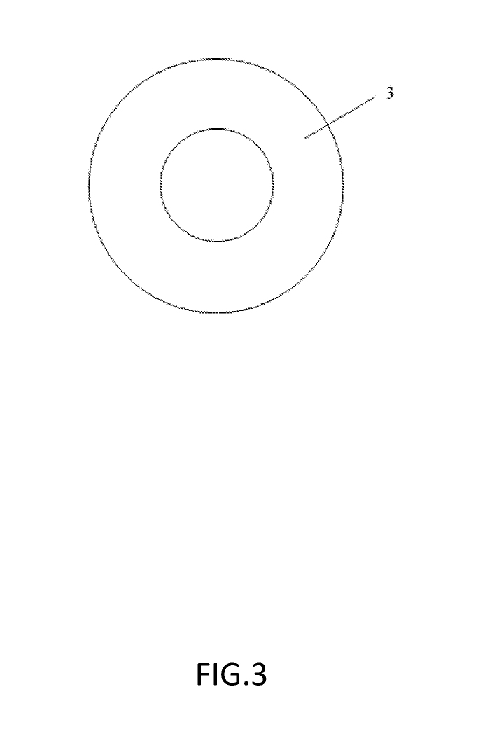

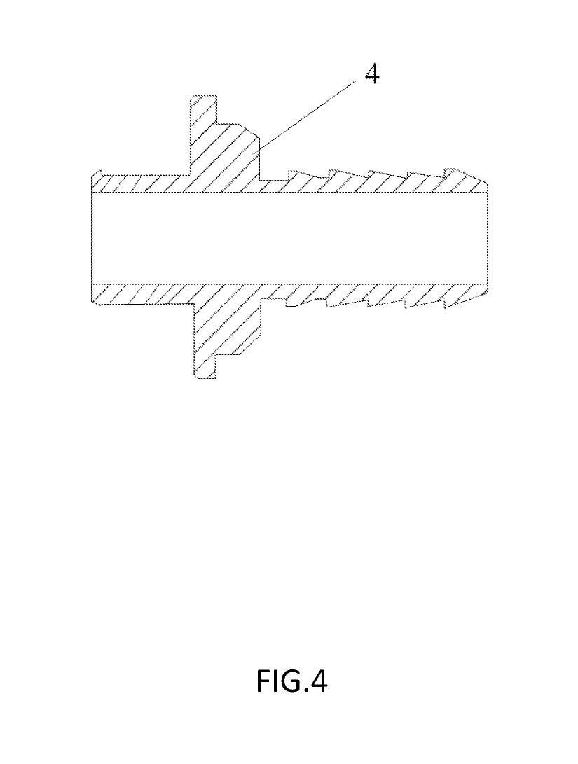

Please refer to FIGS. 1, 2, 3 and 4. The disclosed joint 100 for preventing a water pipe from twisting includes: a hanger screw sleeve 1, a disk-shaped oil seal 2, a gasket 3, and a connecting pipe 4. The disk-shaped oil seal 2 is sleeved on one end of the connecting pipe 4, and the water pipe is sleeved on the other end thereof. The gasket 3 is disposed between the disk-shaped oil seal 2 and the connecting pipe 4. The disk-shaped oil seal 2, the gasket 3 and the connecting pipe 4 are all arranged in the hanger screw sleeve 1. As the hanger screw sleeve 1 screws into a water pipe base and slowly presses onto the disk-shaped oil seal 2, the disk-shaped oil seal 2 and the gasket 3 also rotate together with the hanger screw sleeve 1.

The disk-shaped oil seal 2 further includes: a seal ring 21, a convex ring 22, a filter 23 and a plurality of bosses 24 disposed around the seal ring 21. The convex ring 22 is disposed on one side of the seal ring 21. The filter 23 is disposed inside the convex ring 22.

The filter 23 is a 50-mesh stainless steel filter.

Except for the filter 23, the disk-shaped oil seal 2 is made of a nitrile rubber material.

A steel sleeve 5 is arranged on the end of the connecting pipe 4 that is connected with the water pipe. The steel sleeve is used to fasten the water pipe onto the connecting pipe of the joint.

The working principles of the disclosed joint 100 for preventing a water pipe from twisting are further described as follows. One end of the connecting pipe 4 is sleeved with the gasket 3 and the disk-shaped oil seal 2 in sequence. The filter 23 of the disk-shaped oil seal 2 is on the outermost end of the connecting pipe 4. The other end of the connecting pipe is connected with a water pipe. The steel sleeve 5 is sleeved pm the water pipe end to fasten the connection between the water pipe and the connecting pipe 4. The disk-shaped oil seal 2, the gasket 3, the connecting pipe 4 are all disposed inside the hanger screw sleeve 1. When the disclosed joint 100 is connected to a water pipe base, rotating the hanger screw sleeve 1 will slowly press tightly against the disk-shaped oil seal 2. As the outer side of the disk-shaped oil seal 2 has several bosses 24, the bosses 24 engage against the inner side of the hanger screw sleeve 1. The disk-shaped oil seal 2 also rotates with the hanger screw sleeve 1. Since the gasket 3 is movable, it also rotates with the hanger screw sleeve 1. The connecting pipe 4 and the connected water pipe, however, do not rotate at all. Therefore, no twisting occurs. The sealing effect of the disk-shaped oil seal 2 is better. The filter 23 of the disk-shaped oil seal 2 further has the function of filtering out impurities.

The disclosed joint for preventing a water pipe from twisting has the following advantages. Different from the integrated design of the water pipe joint and the core in the prior art, the invention provides a joint for preventing the water pipe from twisting. Its advantage is that: the hanger screw sleeve screws into a water pipe base and presses onto the disk-shaped oil seal, the disk-shaped oil seal and the gasket also rotate together with the hanger screw sleeve. The connected water does not rotate and therefore does not twist. The disk-shaped oil seal also has a better sealing effect.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A joint for preventing a water pipe from twisting, comprising: a hanger screw sleeve, a disk-shaped oil seal, a gasket, and a connecting pipe, wherein the disk-shaped oil seal is sleeved on one end of the connecting pipe; the water pipe is sleeved on the other end thereof; the gasket is disposed between the disk-shaped oil seal and the connecting pipe; the disk-shaped oil seal, the gasket, and the connecting pipe are all disposed inside the hanger screw sleeve; and as the hanger screw sleeve screws into the base of the water pipe, the hanger screw sleeve slowly presses tightly against the disk-shaped oil seal and both the disk-shaped oil seal and the gasket rotate with the hanger screw sleeve.

2. The joint of claim 1, wherein the disk-shaped oil seal further includes a seal ring, a convex ring, a filter and a plurality of bosses disposed around the seal ring; the convex ring is disposed on one side of the seal ring; and the filter is disposed inside the convex ring.

3. The joint of claim 2, wherein the filter is a 50-mesh stainless steel filter.

4. The joint of claim 1, wherein the disk-shaped oil seal is made of a nitrile rubber material except for the filter.

5. The joint of claim 2, wherein the disk-shaped oil seal is made of a nitrile rubber material except for the filter.

6. The joint of claim 1, wherein a steel sleeve is arranged on the end of the connecting pipe that is connected with the water pipe to fasten the water pipe onto the connecting pipe.
